(19) United States
(12) Patent Application Publication
(10) Pub. No.: US 2025/0022169 A1
(43) Pub. Date: Jan. 16, 2025

(54) IMAGE PROCESSING APPARATUS, IMAGE PROCESSING METHOD, AND STORAGE MEDIUM

(71) Applicant: CANON KABUSHIKI KAISHA, Tokyo (JP)

(72) Inventors: KOJI MAKITA, Kanagawa (JP); SHUNTA TATE, Tokyo (JP)

(21) Appl. No.: 18/766,444

(22) Filed: Jul. 8, 2024

(30) Foreign Application Priority Data
Jul. 10, 2023 (JP) 2023-113182

(51) Int. Cl. G06T 7/73; G06T 3/40; G06V 10/44; G06V 10/764

(52) U.S. Cl. CPC G06T 7/74; G06T 3/40; G06V 10/44; G06V 10/764; G06V 2201/08

(57) ABSTRACT

An image processing apparatus includes one or more memories storing instructions, and one or more processors that, upon execution of the stored instructions, are configured to perform predetermined conversion processing on a first image including a subject to generate a second image, detect feature points of the subject from the first and second images, and determine a reference coordinate system for a detector for detecting feature points based on a relation between a result of detecting feature points in the first image and a result of detecting feature points in the second image.

### BACKGROUND OF THE DISCLOSURE

### Field of the Disclosure

The present disclosure particularly relates to an image processing apparatus suitably used to detect feature points from an image, an image processing method, and a storage medium.

### Description of the Related Art

Conventionally, a technique for detecting and using feature points may be used in detecting and recognizing an object appearing in an image and estimating a depth value of the object. In a case of analyzing and matching feature points, the accuracy of coordinate values of the feature points on the image is important. Japanese Patent Application Laid-Open No. 2007-212430 discusses a method for capturing a measurement target from a plurality of positions by using an imaging apparatus, extracting feature points from captured images, matching the feature points, and measuring a three-dimensional shape of the measurement target.

Generally, a feature point detector outputs the coordinate values of feature points on an image based on the position and orientation of a predetermined coordinate system. However, the position and orientation of the coordinate system to be referenced may be indefinite. In such a case, an error may arise in the positions of feature points.

### SUMMARY OF THE DISCLOSURE

In view of the above-described issue, the present disclosure is directed to estimating the coordinate system to be referenced in detecting feature points from an image.

An image processing apparatus includes one or more memories storing instructions, and one or more processors that, upon execution of the stored instructions, are configured to perform predetermined conversion processing on a first image including a subject to generate a second image, detect feature points of the subject from the first and second images, and determine a reference coordinate system for a detector for detecting feature points based on a relation between a result of detecting feature points in the first image and a result of detecting feature points in the second image.

Further features of the present disclosure will become apparent from the following description of exemplary embodiments with reference to the attached drawings.

### BRIEF DESCRIPTION OF THE DRAWINGS

FIG. 1 is a block diagram illustrating an example of a functional configuration of an image processing apparatus according to an exemplary embodiment.

FIG. 2 is a flowchart illustrating an example of processing for determining a coordinate system.

FIG. 3 illustrates an example of an original image included in an image group.

FIG. 4 illustrates an example of a result of detecting feature points from an original image and a different image.

FIG. 5 illustrates examples of original images with coordinate axes of coordinate systems W₀ and W₁ superimposed thereon.

FIG. 6 is a flowchart illustrating an example of detailed processing for calculating an evaluation value for a coordinate system candidate.

FIG. 7 illustrates an example of a result of converting coordinates of a feature point in the coordinate system W₀.

FIG. 8 illustrates an example of a result of converting coordinates of a feature point in the coordinate system W₁.

FIG. 9 illustrates an example of a result of associating feature points by using labels.

FIG. 10 illustrates a positional error in a certain pair of feature points.

FIG. 11 illustrates a positional error for each pair of feature points in an image.

FIG. 12 illustrates an integrated value of positional errors for each image.

FIG. 13 illustrates an example of detecting face regions from an image.

FIG. 14 illustrates an example of a result of generating different images through horizontal inversion of images.

FIG. 15 illustrates an example of a result of detecting feature points from an original image and a different image.

FIG. 16 illustrates examples of face images with coordinate axes of coordinate systems W₀ and W₁ superimposed thereon.

FIG. 17 illustrates an example of a result of converting coordinates of a feature point in the coordinate system W₀.

FIG. 18 illustrates an example of a result of converting coordinates of a feature point in the coordinate system W₁.

FIG. 19 illustrates an example of a result of associating feature points by using labels.

FIG. 20 illustrates a positional error in a certain pair of feature points.

FIG. 21 illustrates a positional error for each of feature points in an image.

FIG. 22 illustrates an integrated value of positional errors for each image.

FIG. 23 illustrates procedures for determining an associated feature point when using natural feature points with no specific label.

FIG. 24 is a flowchart illustrating an example of processing for calculating a positional error of a certain pair of feature points according to a fifth modification.

FIG. 25 illustrates an example of a result of converting coordinates of a feature point in a coordinate system Wₚ according to the fifth modification.

FIG. 26 illustrates different results of interpreting the position of a feature point on an image in different coordinate systems.

FIG. 27 illustrates examples of different images generated from an original image according to an eighth modification.

FIG. 28 is a flowchart illustrating an example of processing for further optimizing a coordinate system to be referenced according to a ninth modification.

FIG. 29 illustrates an example of a result of detecting feature points in a face image.

FIG. 30 illustrates an example of a result of detecting manually corrected feature points.

FIG. 31 is a block diagram illustrating an example of a hardware configuration of an image processing apparatus according to an exemplary embodiment.

### DESCRIPTION OF THE EMBODIMENTS

Exemplary embodiment of the present disclosure will be described in detail below with reference to the accompanying drawings. Configurations described in the following exemplary embodiments are to be considered as illustrative, and the present disclosure is not limited to illustrated configurations.

The following describes an issue in a feature point detector used in detecting and recognizing an object appearing in an image and estimating a depth value of the object. Conventionally, the coordinate values of a feature point on an image are output with reference to the position and orientation of a predetermined coordinate system. However, the position and orientation of the coordinate system to be referenced may be indefinite. When an existing detector is obtained, the position and orientation of the coordinate system to be referenced may not be specified for the detector, for example, in a case where information about the coordinate system to be referenced is not attached. As another example, even with a detector generated by machine learning, the position and orientation of the reference coordinate system may be unknown because there is a plurality of different coordinate systems to be referenced for data used for the machine learning. As still another example, even with a detector generated by machine learning, estimated coordinate values may include a systematic error because of different properties between the image used in the machine learning and the image to be actually processed.

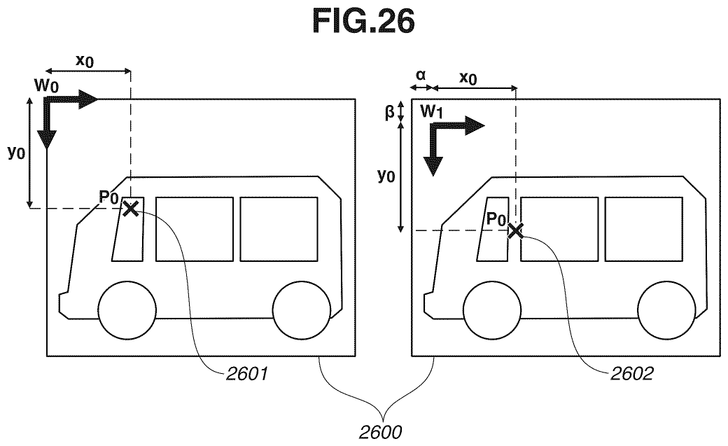

Indefinite position and orientation of the coordinate system to be referenced may be caused by other various factors including mistakes and accuracy variations in generating truth values in data for the learning, a round-off error occurring in storing numerical values indicating feature point positions. Such factors further include various operations including image clipping processing and image enlargement and reduction processing. In such a case, the coordinate values of feature points output by the detector will be interpreted based on a certain coordinate system. However, depending on the coordinate system used, errors in a result of feature point analysis, a result of feature point matching, and a result of three-dimensional shape measurement will increase. An example where an error in an output result increases will be described below with reference to FIG. 26.

FIG. 26 illustrates an example where two different coordinate systems W₀ and W₁ exist. The position of the coordinate system W₁ is rightwardly shifted by α and downwardly shifted by β when viewed from the position of the coordinate system W₀. Assume a case where a certain feature point P₀ is detected from an image 2600, and two-dimensional coordinates (x0, y0) of a feature point P₀ on the image are output. If the coordinate system W₀ is interpreted as the reference coordinate system, the position of the feature point P₀ is the position of a point 2601. If the coordinate system W₁ is interpreted as the reference coordinate system, the position of the feature point P₀ is the position of a point 2602. Which of the coordinate systems W₀ and W₁ is suitable is unknown in this stage. However, if the coordinate system W₁ is a suitable coordinate system, for example, the position of the feature point P₀ is deviated by a distance sqrt(α²+β²) in the coordinate system W₀.

Using a different reference coordinate system in this way differentiates the interpreted position of a feature point on the image, possibly resulting in an error in the output result. Therefore, there has been a demand for a method for identifying the position and orientation of the coordinate system to be referenced. Alternatively, there has been a demand for a method for optimizing the coordinate system to minimize the error if a correct coordinate system cannot be uniquely determined. Exemplary embodiments will be described below centering on a specific example of estimating the coordinate system to be referenced.

A first exemplary embodiment will be described below centering on an image processing apparatus for estimating the coordinate system to be referenced and detecting feature points from a vehicle appearing in an image.

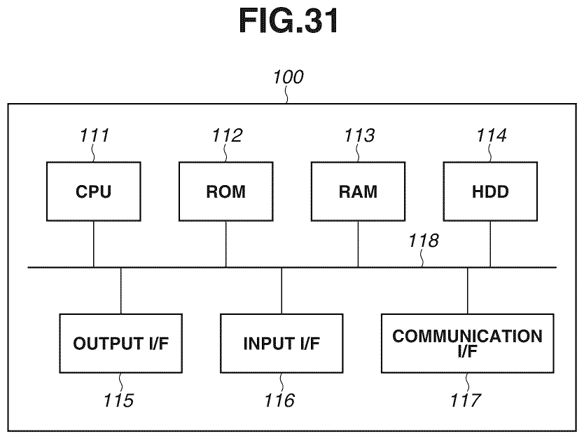

FIG. 31 is a block diagram illustrating an example of a hardware configuration of an image processing apparatus 100 according to the present exemplary embodiment. The image processing apparatus 100 includes a central processing unit (CPU) 111, a read only memory (ROM) 112, a random access memory (RAM) 113, a hard disk drive (HDD) 114, an output interface (I/F) 115, an input I/F 116, and a communication I/F 117 which are all connected via a bus 118. The CPU 111 reads a control program stored in the ROM 112 and executes various kinds of processing. The RAM 113 is used as the main memory of the CPU 111 and a temporary storage such as a work area. The HDD 114 stores various kinds of data and various programs.

The output I/F 115 is an interface for outputting information to a display apparatus for displaying various kinds of information. The input I/F 116 is an interface for inputting various operations by the user via a keyboard and mouse. The communication I/F 117 is an interface for performing wired or wireless communication with an external apparatus such as an image forming apparatus via a network.

The function and processing of the image processing apparatus 100 (described below) are implemented when the CPU 111 reads a program stored in the ROM 112 or the HDD 114 and then executes the program. As another example, the CPU 111 may read a program stored in a recording medium such as a secure digital (SD) card instead of the ROM 112.

In the image processing apparatus 100 according to the present exemplary embodiment, one processor (CPU 111) executes processing illustrated in flowcharts (described below) by using a memory (ROM 112). However, other configurations are also applicable. For example, a plurality of processors, a plurality of RAMs, a plurality of ROMs, a plurality of storages may be cooperatively operated to perform processing illustrated in flowcharts (described below). The above-described processing may be partly executed by hardware circuitry. The function and processing of the image processing apparatus 100 (described below) may be implemented by using a processor other than the CPU 111 (for example, a graphics processing unit (GPU) may be used instead of the CPU 111).

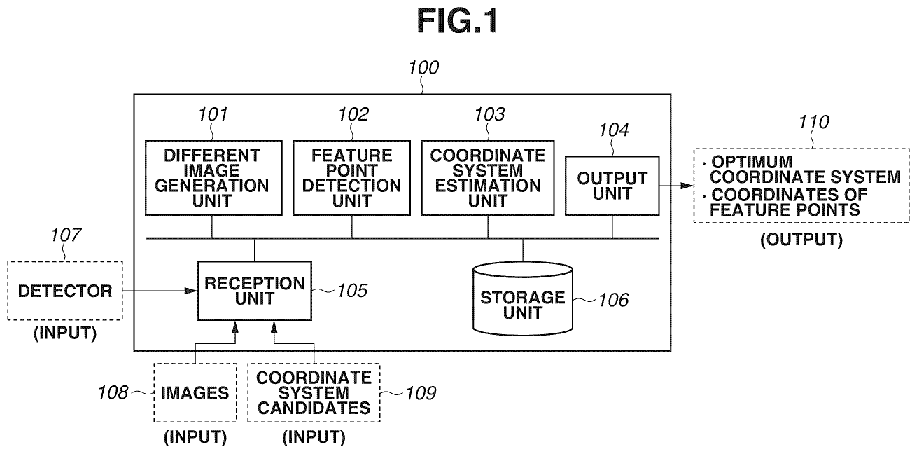

FIG. 1 is a block diagram illustrating an example of a functional configuration of the image processing apparatus 100 according to the present exemplary embodiment.

The image processing apparatus 100 includes a different image generation unit 101, a feature point detection unit 102, a coordinate system estimation unit 103, an output unit 104, a reception unit 105, and a storage unit 106.

The reception unit 105 receives a detector 107, images 108, and coordinate system candidates 109 via the communication I/F 117 and stores them in the storage unit 106.

The different image generation unit 101 generates a different image based on the image 108 stored in the storage unit 106 and stores the different image in the storage unit 106.

The feature point detection unit 102 detects feature points from the image 108 and the image generated by the different image generation unit 101, by using the detector 107 stored in the storage unit 106, and stores the coordinates of the detected feature points in the storage unit 106.

The coordinate system estimation unit 103 determines one coordinate system to be referenced from among the coordinate system candidates 109 stored in the storage unit 106.

The output unit 104 outputs information 110 including the coordinate system to be referenced and the coordinate values of feature points calculated by using the coordinate system to be referenced, stored in the storage unit 106, to an external display apparatus via the output I/F 115.

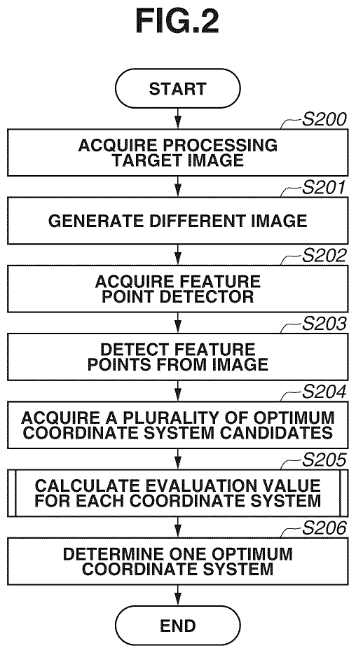

FIG. 2 is a flowchart illustrating an example of processing for determining the coordinate system to be referenced according to the present exemplary embodiment. The processing illustrated in FIG. 2 will be described in detail below with reference to specific data.

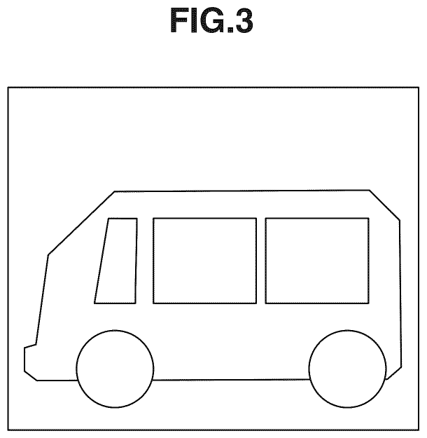

In step S200, the different image generation unit 101 acquires an image to be subjected to the feature point detection processing from the storage unit 106. Hereinafter, the image captured in step S200 is referred to as an original image, and an image to be generated in step S201 (described below) is referred to as a different image. The present exemplary embodiment uses, as an original image, an image group of a vehicle captured with an ordinary camera. FIG. 3 illustrates an example of an image included in the image group. Generally, an image group includes N images (N is an integer equal to or larger than 1), the present exemplary embodiment sets N=10 to simplify the description. Although the number of vehicles appearing in each image is generally unknown, the present exemplary embodiment assumes that one vehicle appears in each image to simplify the description.

If two or more vehicles appear in an acquired image, regions including each vehicle may be detected and clipped to generate clipping images, and then the clipping images may be processed. Regions including each vehicle may be manually clipped by using, for example, a user interface for selecting a rectangular region on the image. For example, rectangular regions including a vehicle may be automatically detected from an image by using a method described in Joseph Redmon, et al., “You Only Look Once: Unified, Real-Time Object Detection”, in arXiv, Submitted on 8 Jun. 2015 (v1), last revised 9 May 2016 (this version, v5), <URL: https://arxiv.org/abs/1506.02640>.

In step S201, the different image generation unit 101 inputs the original image acquired in step S200 and generates a different image. Although the present exemplary embodiment generates a different image through horizontal image inversion, a different image may be generated by using any method as long as the coordinates of feature points associated between the original image and the different image can be calculated. For example, since the homography conversion can calculate the association between the coordinates before and after the conversion through matrix calculation, a different image may be generated by using the homography conversion.

In step S202, the feature point detection unit 102 acquires the detector 107 for detecting feature points from an image, from the storage unit 106. The present exemplary embodiment uses a feature point detector having a deep convolutional neural network (DNN) generated by using a method described in Wenhao Ding, et al., “Vehicle Pose and Shape Estimation through Multiple Monocular Vision”, in arXiv, Submitted on 10 Feb. 2018 (v1), last revised 11 Nov. 2018 (this version, v5), URL: https://arxiv.org/abs/1802.03515 (hereinafter referred to as Wenhao Ding, et al.). However, feature point detectors prepared by other methods are also applicable.

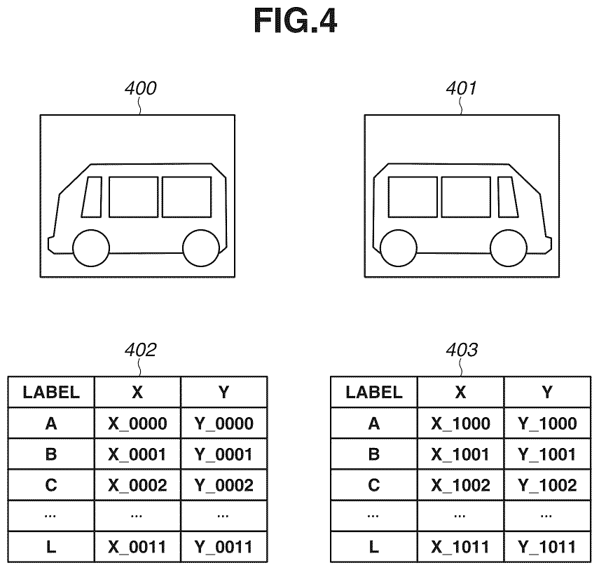

In step S203, the feature point detection unit 102 detects feature points from the original and different images by using the feature point detector acquired in step S202. An example of a result of detecting feature points is illustrated in FIG. 4. The method described in Wenhao Ding, et al. detects 12 different feature points from each vehicle and applies a specific label to each feature point. In the example illustrated in FIG. 4, 12 different labels A, B C . . . J, K, and L are applied to each image. FIG. 4 illustrates labels and coordinates 402 of feature points detected in an original image 400, and labels and coordinates 403 of feature points detected from a different image 401.

In step S204, the coordinate system estimation unit 103 acquires a plurality of candidates of the coordinate system to be referenced, from the storage unit 106. Although the present exemplary embodiment acquires two coordinate systems W₀ and W₁ as candidates to simplify the description, three or more candidates may be acquired. The coordinate system estimation unit 103 may generate coordinate system candidates, for example, through inference based on the data used in the learning of the detector 107. Alternatively, the coordinate system estimation unit 103 may generate a result of feature point detection by using some images and then generate coordinate system candidates through the inference based on the result of feature point detection.

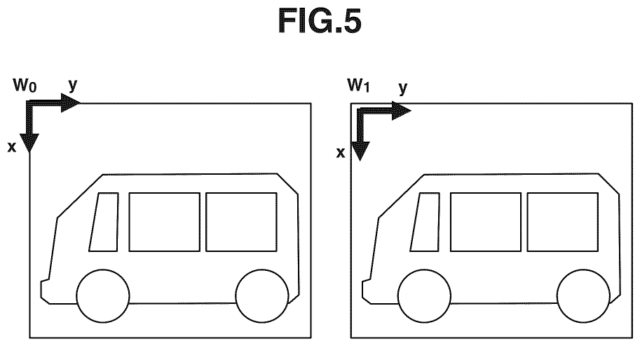

FIG. 5 illustrates examples of the original images captured in step S200 with the coordinate axes of the coordinate systems W₀ and W₁ superimposed thereon. Referring to the examples in FIG. 5, the positions and orientations of the coordinate systems W₀ and W₁ are as follows:

Coordinate system W₀: The origin position is the upper left position of the upper left pixel of an image. The positive side of the X-axis direction is the downward side of the image. The positive side of the Y-axis direction is the rightward side of the image.

Coordinate system W₁: The origin position is the center position of the upper left pixel of an image. The positive side of the X-axis direction is the downward side of the image. The positive side of the Y-axis direction is the rightward side of the image.

In step S205, the coordinate system estimation unit 103 calculates an evaluation value for each of the coordinate system candidates acquired in step S204. According to the present exemplary embodiment, the coordinate system estimation unit 103 calculates evaluation values for the two different coordinate systems W₀ and W₁ acquired in step S204.

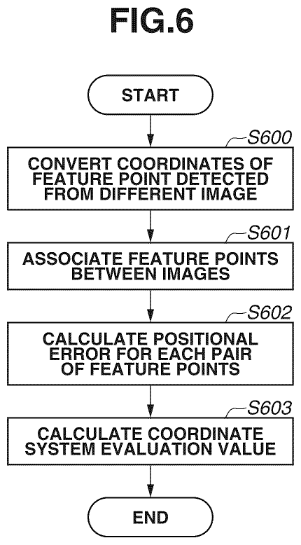

FIG. 6 is a flowchart illustrating an example of detailed processing for calculating an evaluation value for each coordinate system in step S205 in FIG. 2. The processing illustrated in FIG. 6 will be described in detail below.

In step S600, for all images, the coordinate system estimation unit 103 converts the coordinates of a feature point detected from the different image in a coordinate system candidate. The coordinate conversion in this case refers to processing for calculating the coordinates on the original image corresponding to the coordinates of a feature point detected from the different image. The coordinate conversion method is based on the inverse conversion for converting the different image back to the original image. According to the present exemplary embodiment, in step S201, the different image generation unit 101 generates a different image through processing for horizontally inverting the original image. Therefore, as the method of the inverse conversion for converting the different image back to the original image, the coordinate system estimation unit 103 uses a method for horizontally inverting the different image again. Examples of conversion in the two coordinate systems W₀ and W₁ as coordinate system candidates will be described below.

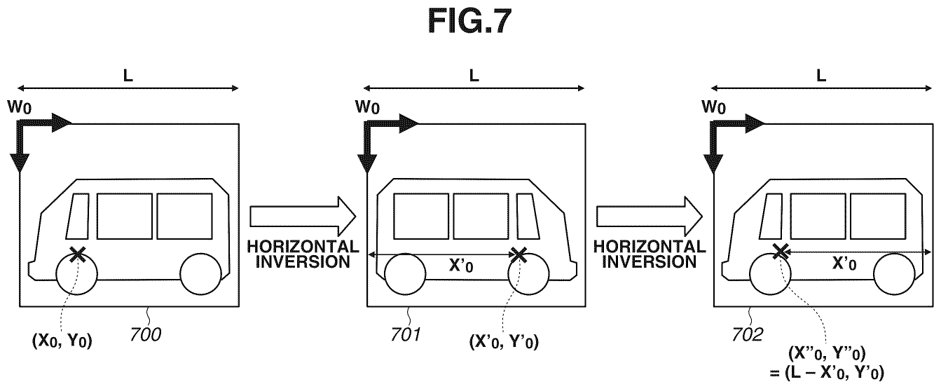

FIG. 7 illustrates an example of a result of generating a different image 701 from an original image 700, detecting a feature point, and converting the coordinates of the feature point in the coordinate system W₀. Referring to FIG. 7, an image 702 is an image as a result of horizontally inverting the different image 701 again. The coordinates (X₀, Y₀) represent the coordinates of the feature point detected from the original image 700. The feature point after the conversion has coordinates (X₀″, Y₀″)=(L−X₀′, Y₀′) where (X₀′, Y₀′) denotes the coordinates of the feature point detected from the different image 701 and L denotes the horizontal width of the images 700 to 702.

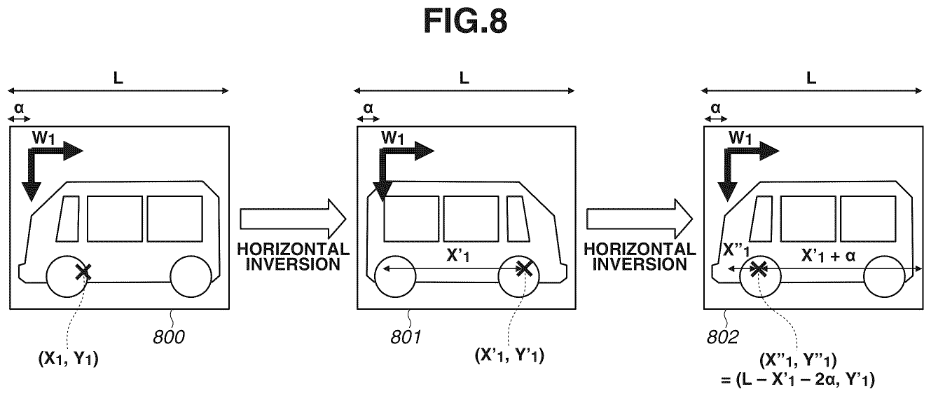

FIG. 8 illustrates an example of a result of generating an image 801 from an original image 800, detecting a feature point, and converting the coordinates of the feature point in the coordinate system W₁. Referring to FIG. 8, an image 802 is an image as a result of horizontally inverting the different image 801 again. The coordinates (X₁, Y₁) represent the coordinates of the feature point detected from the original image 800. The feature point after the conversion has coordinates (X₁″, Y₁″)=(L−X₁′−2α, Y₁′) where (X₁′, Y₁′) denotes the coordinates of the feature point detected from the different image 801, L denotes the horizontal width of the images 800 to 802, and α denotes the radius of pixels.

In step S601, for all images, the coordinate system estimation unit 103 associates the feature point detected from the original image detected in step S203 with the feature point detected from the different image. Generally, there are two different methods for detecting feature points. One method determines a feature point type (for example, facial labels such as the right eye and the nose), and the other method does not determine a feature point type. The method that determines a feature point type associates feature points based on a type. The method that does not determine a feature point type will be described below centering on a method for associating feature points according to a fourth modification.

As described above, the feature points detected in step S203 are assigned specific labels. Therefore, the present exemplary embodiment associates the feature points detected from the original image with the feature points detected from the different image by using specific labels. The different image generation unit 101 generates a different image by horizontally inverting the original image in step S201. Therefore, the coordinate system estimation unit 103 associates the feature points in consideration of the horizontally inverted positions of the detected feature points.

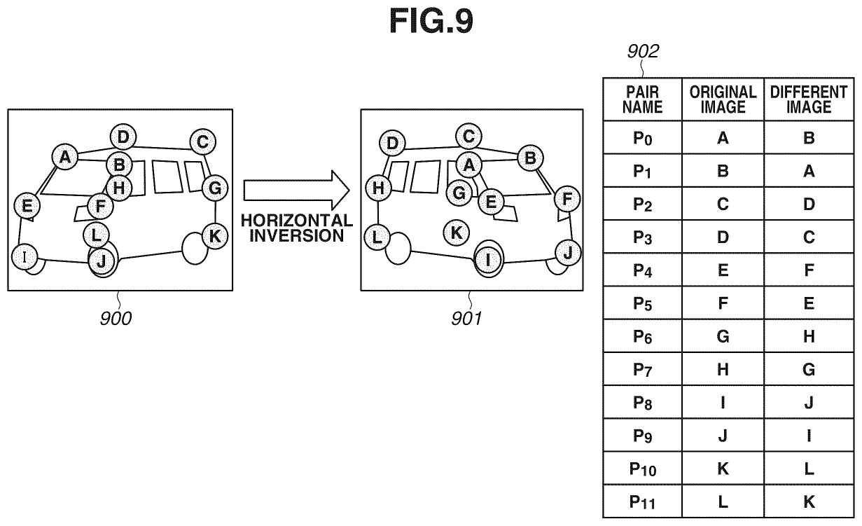

FIG. 9 illustrates an example of a result of associating the 12 detected feature points by using labels A, B, C . . . J, K, and L. Referring to FIG. 9, Table 902 represents a result of feature point association. Pairs P₀, P₁, P₂, . . . , and P₁₁ of feature points included in Table 902 are generated in consideration that a different image 901 is an image as a result of horizontally inverting an original image 900. For example, in consideration of the horizontal inversion, a feature point A included in the original image 900 is associated with a feature point B included in the different image 901. Therefore, the pair P₀ included in Table 902 is a pair of the feature point A included in the original image 900 and the feature point B included in the different image 901. The pairs P₁, P₂, . . . , and P₁₁ included in Table 902 are also generated by associating feature points in similar processing.

In step S602, the coordinate system estimation unit 103 calculates a positional error for each pair of the feature points associated in step S601 in all of the coordinate system candidates. More specifically, the coordinate system estimation unit 103 calculates a positional error by using the square of the Euclidean distance between the position of a feature point detected from the original image 900 and the position of a feature point obtained by converting, in step S600, the position of a feature point detected from the different image 901.

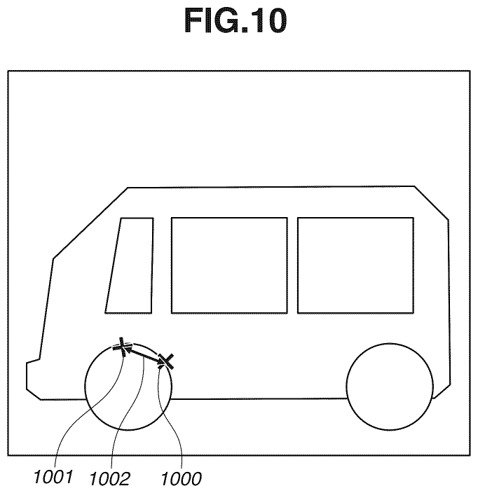

FIG. 10 illustrates a positional error in a certain pair of feature points. Referring to FIG. 10, a point 1000 is a feature point detected from an original image. A point 1001 is a point obtained by converting the position of a feature point forming a pair with the point 1000, through the processing in step S600. An arrow 1002 indicates the Euclidean distance between the points 1000 and 1001.

The coordinate system estimation unit 103 calculates the value of the square of the Euclidean distance as a positional error.

In step S603, the coordinate system estimation unit 103 calculates a coordinate system evaluation value in all of the coordinate system candidates. The coordinate system evaluation value is configured to increase with decreasing positional error calculated in step S602. According to the present exemplary embodiment, therefore, the coordinate system estimation unit 103 calculates an integrated value of the positional errors calculated in step S602 for all images and all pairs of feature points, and uses the negative number as the evaluation value. To simplify the description, the following descriptions will be made on the premise of 10 images each of which includes 12 pairs of feature points. The number of pairs of feature points in each image and the number of images are optional, and calculations can be performed in a similar way even with other values. For example, if there are images in which the entire vehicle appears and images in which the entire vehicle does not appear, the number of pairs of feature points may differ for each image. In addition, the number of calculation target images may decrease to be smaller than the number of initially prepared images because of the image quality and detection performance. Even in such cases, calculations can be performed in a similar way.

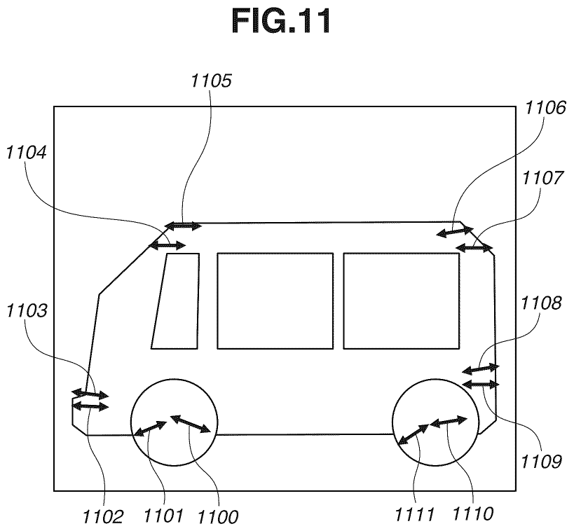

FIG. 11 illustrates positional errors for different pairs of feature points in an image. Referring to FIG. 11, each of arrows 1100 to 1111 indicates the Euclidean distance between two feature points for each of the 12 pairs of feature points calculated in step S602. The coordinate system estimation unit 103 calculates an integrated value E of positional errors in an image by summing up the squares of 12 Euclidean distances (positional errors).

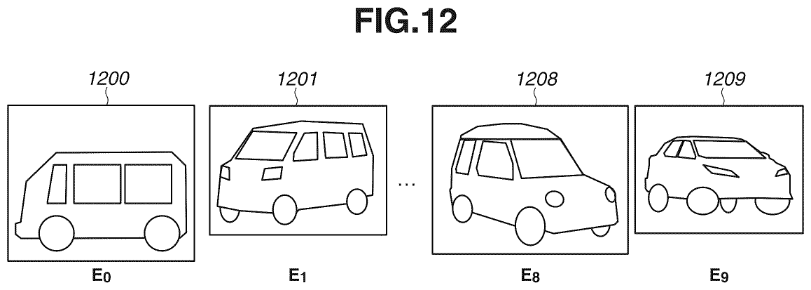

Then, the coordinate system estimation unit 103 sums up the integrated values E of positional errors for 10 different images and assigns the negative sign to obtain an evaluation value of the coordinate system. Referring to FIG. 12, for example, an evaluation value V of the coordinate system is represented by V=−ΣEᵢ (i=0, 1, . . . , and 9) where E₀, E₁, . . . , E₈, and E₉ denote the evaluation values of positional errors for 10 images 1200, 1201, . . . 1208, and 1209, respectively.

Returning to the description of FIG. 2, in step S206, the coordinate system estimation unit 103 selects one coordinate system to be referenced. More specifically, the coordinate system estimation unit 103 selects one coordinate system having the largest evaluation value V out of the evaluation values V calculated in step S205. According to the present exemplary embodiment, out of the two coordinate systems W₀ and W₁ prepared in step S204, the coordinate system estimation unit 103 selects the coordinate system having a larger evaluation value calculated in step S205. The above-described processing enables selecting the coordinate system to be referenced from a plurality of prepared coordinate system candidates.

As described above, if the position and orientation of the coordinate system to be referenced are indefinite, an error arises in interpreting the coordinate output by the feature point detector, resulting in a degraded accuracy of the feature point detecting positions. According to the present exemplary embodiment, the coordinate system estimation unit 103 calculates the evaluation value for each of different coordinate system candidates and then selects the coordinate system having the largest evaluation value in the above-described processing. This enables efficiently estimating the position and orientation of the coordinate system to be referenced, preventing the degradation of the accuracy of feature point detecting positions.

The first exemplary embodiment has been described above centering an example method for selecting one coordinate system to be referenced from reference coordinate system candidates used in interpreting the coordinates of feature point in a case where feature points are detected from an image including a vehicle captured with an ordinary camera. A second exemplary embodiment will be described below centering on a method for selecting the coordinate system to be referenced to accurately detect feature points from a face image. Like the first exemplary embodiment, the internal configuration of the image processing apparatus according to the present exemplary embodiment is similar to the configuration illustrated in FIGS. 1 and 31, and a redundant description thereof will be omitted. According to the present exemplary embodiment, the procedures for selecting a coordinate system for accurately detecting feature points also basically conform to the procedures illustrated in FIG. 2 like the first exemplary embodiment. The processing illustrated in FIG. 2 including a specific example of data will be described in detail below.

In step S200, the different image generation unit 101 acquires processing target images. According to the present exemplary embodiment, the different image generation unit 101 detects face regions from a personal image group captured with an ordinary camera and stored, and acquires face images. Although the present exemplary embodiment detects personal face regions by using a method described in Yepeng Liu, et al., “MOS: A Low Latency and Lightweight Framework for Face Detection, Landmark Localization, and Head Pose Estimation”, in arXiv, Submitted on 21 Oct. 2021 (v1), last revised 1 Nov. 2021 (this version, v3), <URL: https://arxiv.org/abs/2110.10953> (hereinafter referred to as Yepeng Liu, et al.), other methods for detecting personal face regions are also applicable.

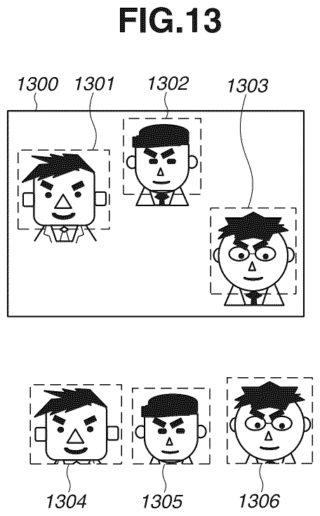

FIG. 13 illustrates an example of detecting face regions from an image. Referring to FIG. 13, an image 1300 indicates an image included in a personal image group captured with an ordinary camera, and face regions 1301, 1302, and 1303 are detected by using the method described in Yepeng Liu, et al. Face images 1304, 1305, and 1306 are clipped from the face regions 1301, 1302, and 1303, respectively, and then stored. Generally, an image group includes N face images (N is an integer equal to or larger than 1), the present exemplary embodiment sets N=10 to simplify the description.

In step S201, the different image generation unit 101 generates different images based on the face images (original images) acquired in step S200. The method for generating a different image is basically similar to that according to the first exemplary embodiment.

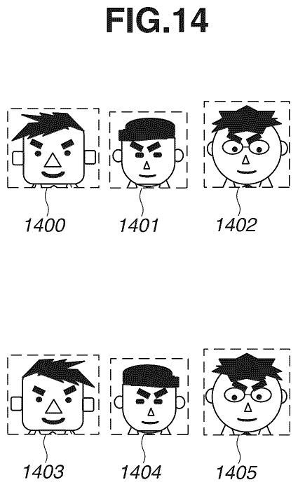

FIG. 14 illustrates an example of a result of generating different images through horizontal image inversion. Referring to FIG. 14, images 1400, 1401, and 1402 indicate examples of the face images (original images) acquired in step S200, and images 1403, 1404, and 1405 indicate examples of the different images generated in step S201.

In step S202, the feature point detection unit 102 acquires from the storage unit 106 a detector for detecting facial organ points as feature points from an image. This processing is basically similar to the processing according to the first exemplary embodiment except for the detector type.

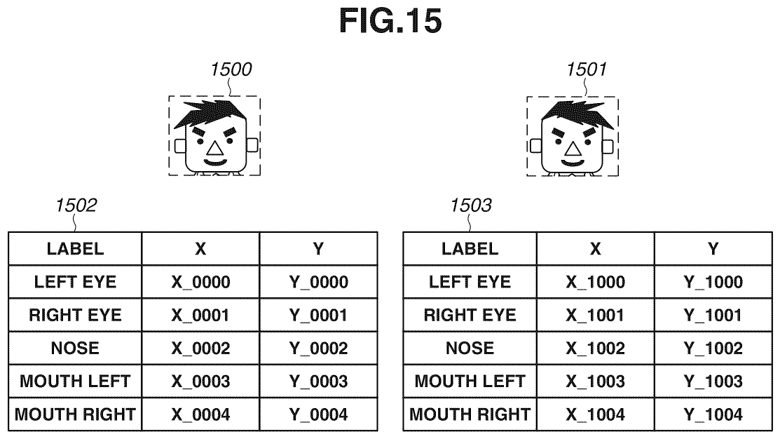

In step S203, the feature point detection unit 102 detects feature points from an original image captured in step S200 and a different image generated in step S201 by using the feature point detector acquired in step S202. The present exemplary embodiment detects feature points from a face image by using the method described in Yepeng Liu, et al. FIG. 15 illustrates an example of a result of detecting feature points. This method detects five different feature points (center of the left eye, center of the right eye, center of the nose, right end point of the mouse, and left end point of the mouse) from one face region and applies specific labels to these feature points. The specific labels include Left eye, Right eye, Nose, Mouth left, and Mouth right. Referring to FIG. 15, Table 1502 represents the labels and coordinate values of the five feature points detected from an original image 1500, and Table 1503 represents labels and coordinate values of the five feature points detected from a different image 1501.

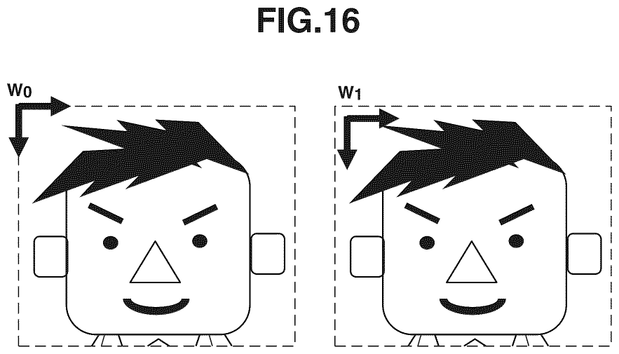

In step S204, the coordinate system estimation unit 103 acquires a plurality of candidates of the coordinate system to be referenced from the storage unit 106. Although two different coordinate systems W₀ and W₁ are acquired as candidates to simplify the description like the first exemplary embodiment, three or more candidates may be acquired. FIG. 16 illustrates examples of images with the coordinate axes of the coordinate systems W₀ and W₁ superimposed on a face image acquired in step S200. The positions and orientations of the coordinate systems W₀ and W₁ are similar to those according to the first exemplary embodiment.

In step S205, the coordinate system estimation unit 103 calculates evaluation values for the coordinate system candidates acquired in step S204. Like the first exemplary embodiment, the processing in step S205 also basically conforms to the procedures illustrated in FIG. 6. The processing will be described in detail below with reference to the accompanying drawings.

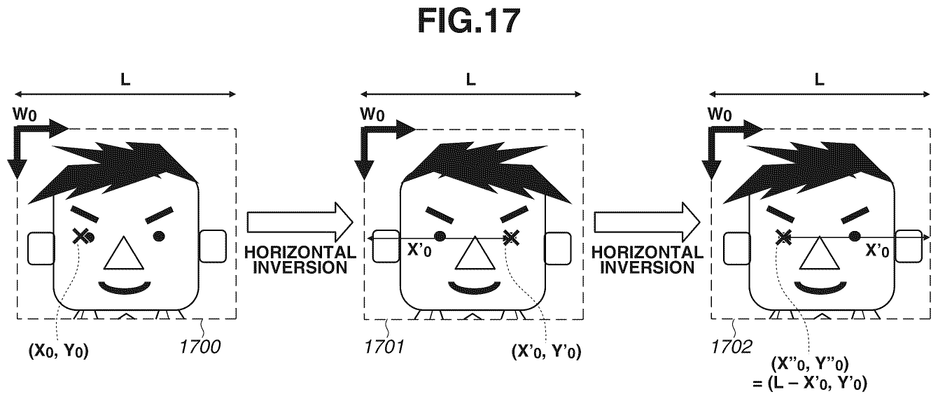

In step S600, the coordinate system estimation unit 103 converts the coordinates of a feature point detected from a different image. FIG. 17 illustrates an example of generating a different image 1701 from an original image 1700, detecting a feature point, and converting the coordinates of the feature point. Referring to FIG. 17, an image 1702 is an image as a result of horizontally inverting the different image 1701 again. The coordinates (X₀, Y₀) represent the coordinates of the feature point detected from the original image 1700. The feature point after the conversion has coordinates (X₀″, Y₀″)=(L−X₀′, Y₀′) where (X₀′, Y₀′) denotes the coordinates of the feature point detected from the different image 1701 and L denotes the horizontal width of the images 1700 to 1702.

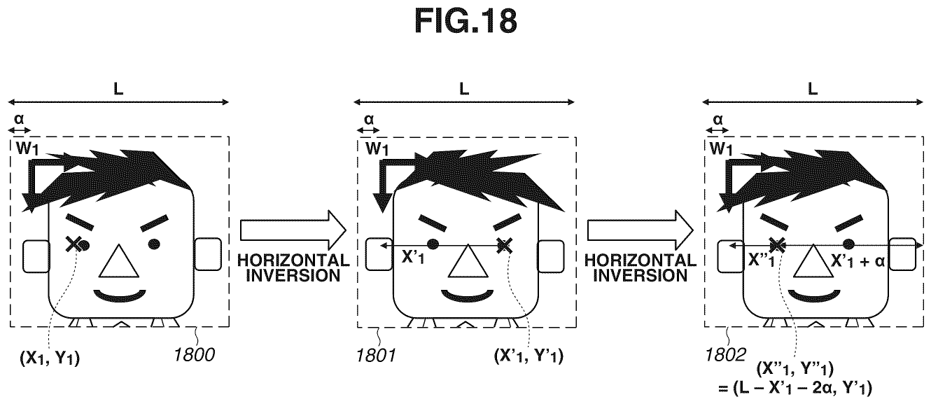

FIG. 18 illustrates an example of generating a different image 1801 from an original image 1800, detecting a feature point, and converting the coordinates of the feature point in the coordinate system W₁. An image 1802 is an image as a result of horizontally inverting the different image 1801 again. The coordinates (X₁, Y₁) represent the coordinates of a feature point detected from the original image 1800. The feature point after the conversion has coordinates (X₁″, Y₁″)=(L−X₁′−2α, Y₁′) where (X₁′, Y₁′) denotes the coordinates of the feature point detected from the different image 1801, α denotes the radius of pixels, and L denotes the horizontal width of the images 1800 to 1802.

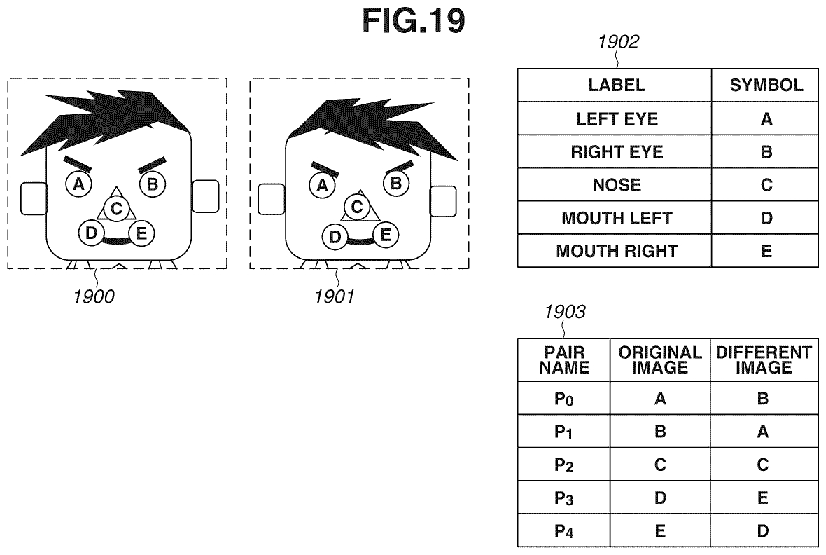

In step S601, the coordinate system estimation unit 103 associates feature points detected from the original image 1800 with feature points detected from the different image 1801. FIG. 19 illustrates a result of associating five different detected feature points A to E by using labels Left eye, Right eye, Nose, Mouth left, and Mouth right, respectively. Referring to FIG. 19, Table 1902 indicates the association between the label names of the feature points and the symbols of the feature points, and Table 1903 indicates a result of the association between the feature points.

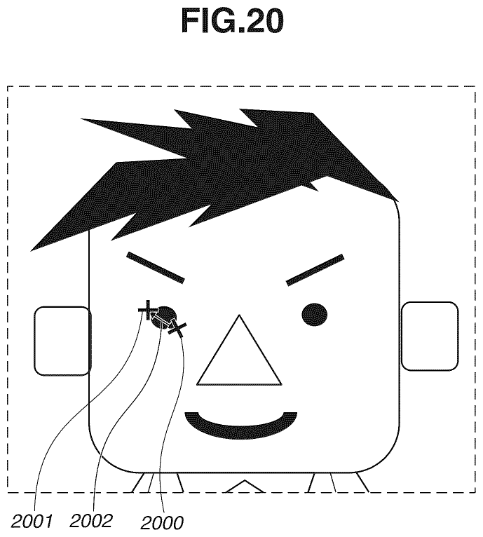

In step S602, the coordinate system estimation unit 103 calculates a positional error for each pair of the feature points associated in step S601. Like the first exemplary embodiment, the positional error is the square of the Euclidean distance between two feature points. An arrow 2002 in FIG. 20 indicates the Euclidean distance between a feature point 2000 detected from the original image and a point 2001 obtained in the conversion in step S600.

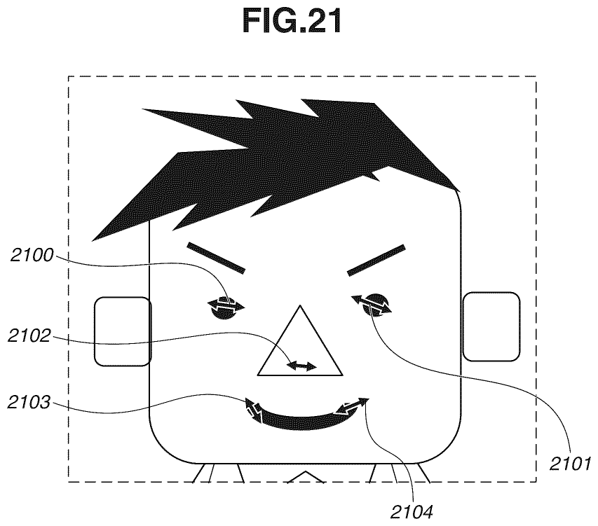

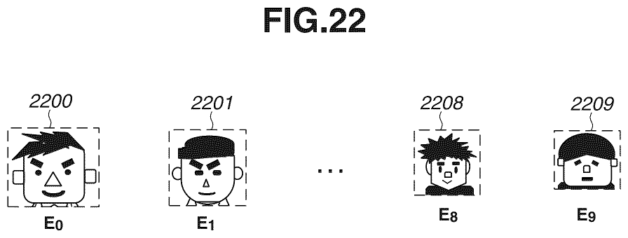

In step S603, the coordinate system estimation unit 103 calculates an evaluation value of the coordinate system. As illustrated in FIGS. 21 and 22, the coordinate system estimation unit 103 calculates integrated values E₀, E₁, . . . , and E₉ of positional errors indicated by the arrows 2100 to 2104 in 10 different face images 2200 to 2209, respectively, by using similar procedures to those according to the first exemplary embodiment. Then, the coordinate system estimation unit 103 obtains an evaluation value V for each coordinate system.

In step S206, like the first exemplary embodiment, the coordinate system estimation unit 103 can efficiently estimate the coordinate system to be referenced for face images as described above, preventing the degradation of the accuracy of feature point detecting positions.

### First Modification

According to the first and second exemplary embodiments, the feature point detection unit 102 detects feature points from an original image input from outside and a different image as a result that the original image is horizontally inverted by the different image generation unit 101. Therefore, the resolution of images to be subjected to feature point detection by the feature point detection unit 102 is only the resolution of the original image input from outside.

On the other hand, the accuracy of feature point detection by the detector may differ according to the resolution of an input image. Therefore, the different image generation unit 101 may generate an image subjected to resolution change based on the image input from outside for use as a new processing target image. For example, if the feature point detection unit 102 detects a specific subject from the image received by the reception unit 105 and the detection of the subject is successful, the different image generation unit 101 generates two different images (an image with the halved vertical and horizontal lengths of the image 108 and an image with the doubled vertical and horizontal lengths of the image 108) as new input images, and then stores the images in the storage unit 106. Then, the feature point detection unit 102 detects the same subject in the newly generated images. The different image generation unit 101 repeats this processing until the subject can no longer be detected to generate a plurality of processing target images.

If the range of the resolution of the processable image as a specification of the detector input from outside is known, the different image generation unit 101 may enlarge or reduce the image received by the reception unit 105 so as to fit into the range of the resolution of the image processable by the detector and generate a new processing target image.

### Second Modification

According to the first and second exemplary embodiments, the feature point detection unit 102 detects feature points from an original image input from outside and a different image as a result that the original image is horizontally inverted by the different image generation unit 101. Therefore, the resolution of images to be subjected to the feature point detection by the feature point detection unit 102 is only the resolution of the original image input from outside.

On the other hand, in detecting feature points, the user may want to detect feature points optimum for an image with a specific resolution. For example, if the user wants to detect optimum feature points for an image with a specific resolution R, and the resolution of an original image input from outside coincides with the resolution R, the different image generation unit 101 generates a different image by using only a conversion method in which the resolution of the original image remains unchanged.

On the other hand, if the resolution of an original image input from outside does not coincide with the resolution R, the different image generation unit 101 may generate a different image by using only a conversion method in which the resolution of the different image becomes the resolution R.

### Third Modification

According to the first and second exemplary embodiments, any number of original images from outside are input and the coordinate system estimation unit 103 determines one coordinate system to be referenced for all processing target images. Meanwhile, it may be more effective to classify original images input from outside into any one of a plurality of sets and then determine one coordinate system to be referenced, for each set. In such a case, the CPU 111 may serve as a classification unit for classifying original images input from outside into a plurality of image groups, and then estimating the coordinate system to be referenced and detecting feature points for each image group.

For example, original images input from outside may include images with a general viewing angle and images with a wide viewing angle. In such a case, the classification unit may classify images into a plurality of image groups based on image information for each image, including the aspect ratio and imaging conditions such as the lens type used in imaging, and then estimate the coordinate system to be referenced and detect feature points for each image group. The classification unit may estimate the direction of a light source based on images and classify images into a plurality of image groups based on the direction of the light source, and then estimate the coordinate system to be referenced and detect feature points for each image group. Further, the classification unit may classify images into a plurality of image groups based on the orientations and sizes of faces appearing in each image, and then estimate the coordinate system to be referenced and detect feature points for each image group.

### Fourth Modification

The first and second exemplary embodiments use a specific label for each of detected feature points, detects feature points, and performs association between the detected feature points. On the other hand, a method for detecting feature points having no specific label is also applicable.

In the fields of camera position and orientation estimation, three-dimensional reconfiguration, and stereo matching, there may be used a technique for detecting natural feature points having no specific label without premising any specific subject. For example, there may be used a method for inputting images including a subject and detecting natural feature points having no specific label, such as a method described in Michal J. Tyszkiewicz, et al., “DISK: Learning local features with policy gradient”, in NeurIPS 2020, <URL: https://papers.nips.cc/paper/2020/file/a42a596fc71e17828440030074d15e74-Paper.pdf>.

On the other hand, if natural feature points having no specific label are used, the CPU 111 needs to perform feature point association by using a method different from the method according to the first and second exemplary embodiments. In such a case, for example, the CPU 111 needs to determine the associated feature point for each of the feature points detected from the original image. More specifically, the CPU 111 determines, as the associated feature point, the feature point having the closest coordinates out of converted coordinates of feature points detected from the different image.

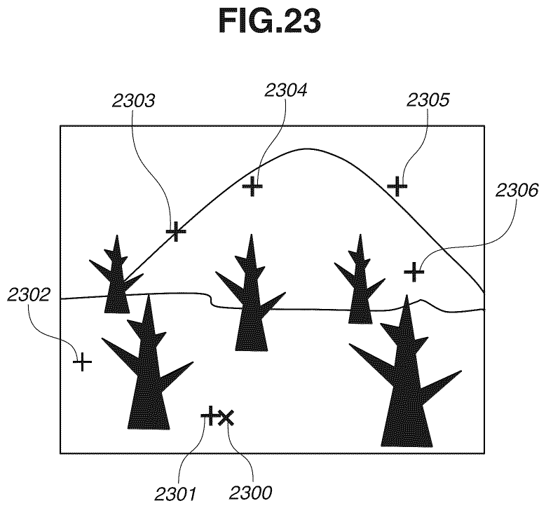

FIG. 23 illustrates procedures for determining the associated feature point. Referring to FIG. 23, a feature point 2300 indicates a feature point detected from the original image. Points 2301 to 2306 indicate the positions of feature points obtained through the coordinate conversion in step S600 in FIG. 6 after the feature point detection from the different image. Referring to the example in FIG. 23, the CPU 111 selects a point 2301 having the shortest distance from the feature point 2300 as a point associated with the feature point 2300 detected from the original image. If a specific feature quantity or feature vector is defined for each feature point, the CPU 111 may determine the feature point having the minimum difference in the feature quantity or feature vector as the associated feature point.

### Fifth Modification

The first and second exemplary embodiments preset a plurality of coordinate system candidates and determine one coordinate system from among these candidates. On the other hand, instead of setting a plurality of coordinate system candidates, the CPU 111 may define one coordinate system having variable position and orientation parameters, optimize the parameters through analytical calculations, and set a coordinate system to be referenced.

Like the first and second exemplary embodiments, the CPU 111 may preset a plurality of coordinate system candidates and include in the candidates the coordinate system having position and orientation parameters as a candidate. In a case of a coordinate system not having position and orientation parameters, the CPU 111 calculates an evaluation value by using the method according to the first and second exemplary embodiments. In a case of a coordinate system having position and orientation parameters, the CPU 111 optimizes the parameters by using a method (described below) and calculates an evaluation value. A method for optimizing the parameters of a coordinate system having position and orientation parameters will be described in detail below.

Firstly, a coordinate system W₀ to be referenced for analytical calculations, and a coordinate system Wₚ having two different parameters (α, β) are defined as candidates. The coordinate system W₀ is similar to that according to the first and second exemplary embodiments. The coordinate system Wₚ is the coordinate system to be referenced for the coordinates of feature points output by the feature point detector, and is defined as follows:

Coordinate system Wₚ: The positive side of the X-axis direction is the downward side of the image. The positive side of the Y-axis direction is the rightward side of the image. The origin position (α, β) is the position deviated from the origin of the coordinate system W₀ by α in the X-axis direction and β in the Y-axis direction.

With the coordinate system Wₚ, if a general affine conversion is used to generate a different image, the integrated value E of positional errors calculated in step S603 in FIG. 6 is represented by a quadratic equation of parameters α and β. Since the parameters α and β are independent of each other, the parameters α and β for minimizing a positional error can be obtained by solving a problem of minimizing a general quadratic function. A method for representing a positional error for a certain pair of feature points as a quadratic function having parameter α and β as variables, and calculating the parameter α and β for minimizing the integrated value E of positional errors will be described below.

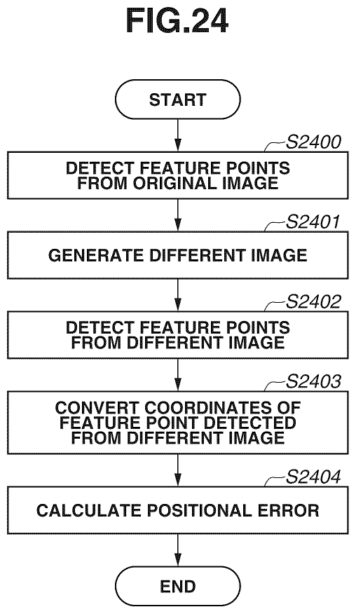

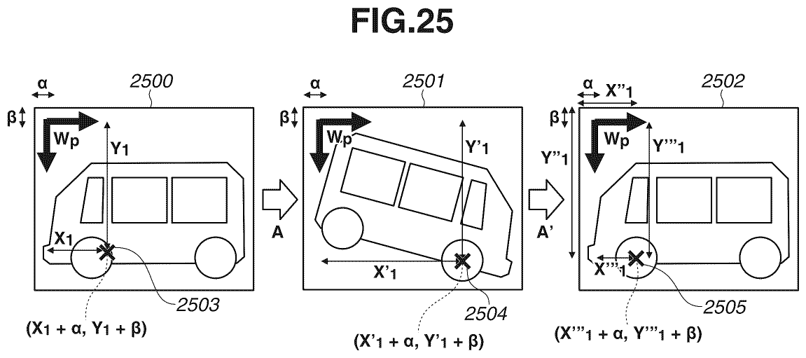

FIG. 24 is a flowchart illustrating an example of processing for calculating a positional error for a certain pair of feature points. The processing illustrated in FIG. 24 is performed as part of the processing in step S602 in FIG. 6. The processing illustrated in FIG. 24 will be described below with reference to FIG. 25.

In step S2400, the feature point detection unit 102 detects a feature point from the original image. Referring to FIG. 25, if a feature point 2503 output by the detector from the original image 2500 based on the coordinate system Wₚ has coordinates (X₁, Y₁), the feature point 2503 based on the coordinate system W₀ has coordinates (X₁+α, Y₁+β).

In step S2401, the different image generation unit 101 generates a different image from the original image. According to the present modification, the different image generation unit 101 generates a different image by using a general affine conversion. If a certain point on the original image 2500 has coordinates (x, y), a certain point on a different image 2501 has coordinates (x′, y′), and an affine conversion matrix A is used to generate the different image 2501 from the original image 2500, the following equation (1) is given.

$$\\ \begin{matrix}( \begin{matrix}{x}^{{}_{} ′} \\ {y}^{{}_{} ′} \\ 1\end{matrix} ) = A ( \begin{matrix}x \\ y \\ 1\end{matrix} ) & ( 1 )\end{matrix}$$

A matrix A in equation (1) is defined by the following equation (2):

$$\\ \begin{matrix}A = ( \begin{matrix}a & b & c \\ d & e & f \\ 0 & 0 & 1\end{matrix} ) & ( 2 )\end{matrix}$$

In step S2402, the feature point detection unit 102 detects a feature point from the different image. Referring to FIG. 25, a feature point 2504 detected from the different image 2501 is a feature point associated with the feature point 2503 detected from the original image. If the feature point 2504 output by the detector based on the coordinate system Wₚ has coordinates (X₁′, Y₁′), the feature point 2504 based on the coordinate system W₀ has coordinates (X₁′+α, Y₁′+β).

In step S2403, the coordinate system estimation unit 103 converts the coordinates of a feature point detected from the different image. Referring to FIG. 25, an image 2502 is generated by the affine conversion for converting the different image 2501 back to the original image 2500 (hereinafter referred to as the inverse affine conversion). An affine conversion matrix A′ for the inverse affine conversion is the inverse matrix of the matrix A.

A feature point 2505 is obtained by converting the feature point 2504 through the inverse affine conversion. Therefore, if the feature point 2505 has coordinates (X₁″, Y₁″) based on the coordinate system W₀, the following equation (3) is given. If the matrix A′ in equation (3) is defined by the following equation (4), the following two equations (5) and (6) are given.

$$\\ \begin{matrix}( \begin{matrix}{X}_{1}^{{}_{} ″} \\ {Y}_{1}^{{}_{} ″} \\ 1\end{matrix} ) = {A}^{{}_{} ′} ( \begin{matrix}{X}_{1}^{{}_{} ′} + α \\ {Y}_{1}^{{}_{} ′} + β \\ 1\end{matrix} ) & ( 3 )\end{matrix}$$

$$\\ \begin{matrix}{A}^{{}_{} ′} = ( \begin{matrix}{a}^{{}_{} ′} & {b}^{{}_{} ′} & {c}^{{}_{} ′} \\ {d}^{{}_{} ′} & {e}^{{}_{} ′} & {f}^{{}_{} ′} \\ 0 & 0 & 1\end{matrix} ) & ( 4 )\end{matrix}$$

$$\\ \begin{matrix}{X}_{1}^{{}_{} ″} = {a}^{{}_{} ′} ( {X}_{1}^{{}_{} ′} + α ) + {b}^{{}_{} ′} ( {Y}_{1}^{{}_{} ′} + β ) + {c}^{{}_{} ′} & ( 5 )\end{matrix}$$

$$\\ \begin{matrix}{Y}_{1}^{{}_{} ″} = {d}^{{}_{} ′} ( {X}_{1}^{{}_{} ′} + α ) + {e}^{{}_{} ′} ( {Y}_{1}^{{}_{} ′} + β ) + {f}^{{}_{} ′} & ( 6 )\end{matrix}$$

If the feature point 2505 has coordinates (X₁″′, Y₁″′) based on the coordinate system Wₚ, the following equations (7) and (8) are given.

$$\\ \begin{matrix}{X}_{1}^{{}_{} ′ ′ ′} = {X}_{1}^{{}_{} ″} - α & ( 7 )\end{matrix}$$

$$\\ \begin{matrix}{Y}_{1}^{{}_{} ′ ′ ′} = {Y}_{1}^{{}_{} ″} - β & ( 8 )\end{matrix}$$

In step S2404, the coordinate system estimation unit 103 calculates a positional error. The magnitude of a positional error Diff equals the square of the distance between the feature points 2503 and 2505 and is represented by the following equation (9):

$$\\ \begin{matrix}Diff = {( {X}_{1} - {X}_{1}^{{}_{} ′ ′ ′} )}^{2} + {( {Y}_{1} - {Y}_{1}^{{}_{} ′ ′ ′} )}^{2} & ( 9 )\end{matrix}$$

The right-hand sides of equations (5) to (8) are linear equations of the parameters α and β. Therefore, if the equations (5) to (8) are assigned to equation (9), the right-hand side of equation (9) becomes a quadratic function of the parameters α and β.

A method for calculating the parameters α and β for minimizing the integrated value E of positional errors will be described below. If there are m calculation target feature points (m is an integer equal to or larger than 1), the integrated value E of positional errors can be defined by the following equation (10) where Diffi (i=1, 2, . . . ,and m) denotes the positional error for each feature point.

$$\\ \begin{matrix}E = {\sum }_{i = 1}^{m} {Diff}_{i} & ( 10 )\end{matrix}$$

Since the integrated value E is the sum of positional errors of all feature points, the result becomes a quadratic function of the two parameters α and β like equation (9). Since the parameters α and β are independent of each other, the parameters α and β for minimizing the integrated value E may be obtained by solving a problem of minimizing a general quadratic function. The parameters α and β for minimizing the integrated value E of positional errors can be obtained if there is at least one feature point. However, from a statistical point of view, using as many feature points as possible enables obtaining more optimum parameters α and β.

The present modification has been described above centering on an example where the parameters α and β representing a positional shift out of coordinate system characterizing parameters are optimized. However, an affine parameter having six degrees of freedom including shearing, such as the following equation (11), may be subjected to the optimization. In this case, the six variables can be optimized by using at least three feature points. As described above, various forms of coordinate system optimization are considered, and the optimization method is not limited to a specific method.

$$\\ \begin{matrix}P = ( \begin{matrix}{p}_{11} & {p}_{12} & {p}_{13} \\ {p}_{21} & {p}_{22} & {p}_{23} \\ 0 & 0 & 1\end{matrix} ) & ( 11 )\end{matrix}$$

### Sixth Modification

The first and second exemplary embodiments process an image of a specific object captured with an ordinary camera. Therefore, depending on a subject, it may be difficult to collect a sufficient number of types of images and a sufficient number of images. In such a case, not only images captured with an ordinary camera but also artificially generated images may be used, and the coordinate system to be referenced may be estimated by using only artificially generated images.

For example, assume a case of acquiring a personal face image. Although a face image captured from the front direction can be easily acquired, a face image captured from an oblique direction or a face image with a strong cast shadow due to the light source position may not be easily acquired. A face image captured from an oblique direction or a face image with a strong cast shadow are artificially generated, and a face image captured from the front direction and an artificially generated face image may be used at the same time. For example, an artificial image is generated by rendering a personal three-dimensional computer graphics (3DCG) model based on various settings.

### Seventh Modification

The first and second exemplary embodiments calculate positional errors for each image of the acquired image group to determine the coordinate system to be referenced. With an image having a large positional error calculated based on the coordinate system to be referenced, it is likely that the positional accuracy of detected feature points is low. As an application of this assumption, image selection in an image group may be performed based on a positional error.

For example, in generating a face image for learning or evaluating a DNN for face recognition, a face image may be generated based on the positions of feature points detected in the face. For example, a method described in Jiankang Deng, et al., “ArcFace: Additive Angular Margin Loss for Deep Face Recognition”, in arXiv, Submitted on 23 Jan. 2018 (v1), last revised 4 Sep. 2022 (this version, v4), <URL: https://arxiv.org/abs/1801.07698> (hereinafter referred to as Jiankang Deng, et al.) performs an affine conversion so that five different feature points detected from a face image come as close to five different predetermined coordinates as possible to generate normalized image groups with the same size.

As a face image to be used in learning or evaluation, an image having a feature point positional accuracy lower than a predetermined value may be eliminated as noise. For example, according to the second exemplary embodiment, the CPU 111 may subject the face images 2200 to 2209 illustrated in FIG. 22 to noise determination based on the integrated values E₀ to E₉ of positional errors for each image. In this case, since the face images 2200 to 2209 have different sizes, the CPU 111 normalizes each of the integrated values E₀ to E₉ of positional errors with different image sizes, and calculates integrated values E₀′ to E₉′ after the normalization. Then, the CPU 111 determines an image having an integrated value equal to or larger than a predetermined value as noise.

If the reception unit 105 receives input images having been normalized to a specific size in advance, the normalization for calculating the integrated values E₀′ to E₉′ may be omitted. For example, if normalized image groups having the same size are pre-generated with the method discussed in Jiankang Deng, et al., the CPU 111 handles the normalized image groups as input images. Then, the CPU 111 calculates the integrated value E of positional errors for each image with the procedures illustrated in FIG. 2, and determines an image having an integrated value E equal to or larger than a predetermined value as noise.

### Eighth Modification

The first and second exemplary embodiments use conversion processing for horizontal image inversion in generating a different image from an original image. The CPU 111 may generate a different image by using any type of method as long as the coordinates of feature points associated between the original and the different images can be calculated. For example, the CPU 111 may generate a different image by using, for example, vertical inversion, translation, enlargement/reduction, rotation, and shearing. The CPU 111 may generate a different image by using such conversion that a rectangular region on the original image is converted into a trapezoid on the different image (hereinafter referred to as trapezoidal conversion). Further, the CPU 111 may use a conversion that combines these conversion methods.

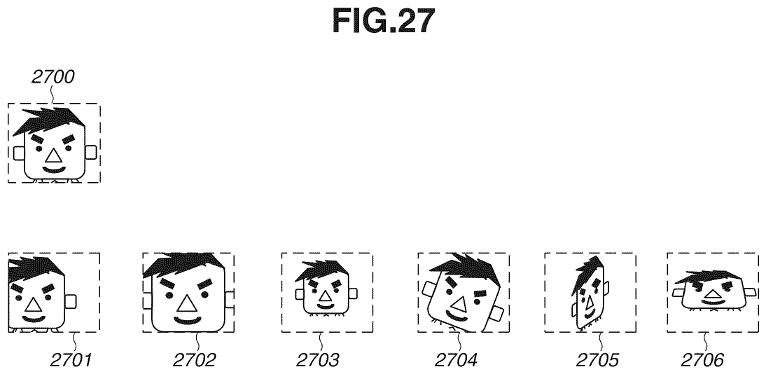

FIG. 27 illustrates examples of different images generated from an original image. Referring to FIG. 27, a different image 2701 is generated as a result of translating an original image 2700. A different image 2702 is generated as a result of enlarging the original image 2700, and a different image 2703 is generated as a result of reducing the original image 2700. A different image 2704 is generated as a result of rotating the original image 2700, and a different image 2705 is generated as a result of shearing the original image 2700. A different image 2706 is generated as a result of trapezoidally converting the original image 2700.

### Ninth Modification

The first and second exemplary embodiments associate feature points detected from the original image with feature points detected from the different image, and determines the coordinate system to be referenced based on the distances between associated feature points. As another modification, the CPU 111 may further optimize the coordinate system to be referenced, by using truth values of coordinates. The following procedures input the coordinate system determined in the second exemplary embodiment and determine the further optimum coordinate system.

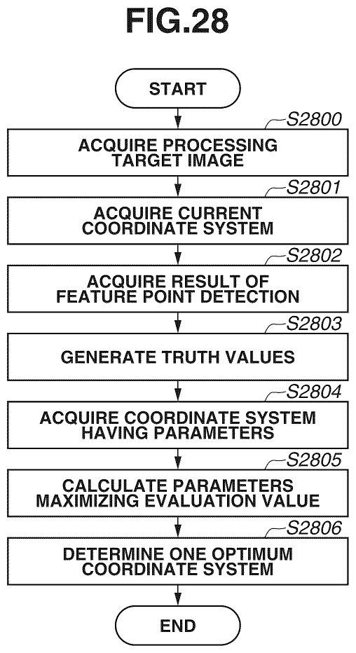

FIG. 28 is a flowchart illustrating an example of processing for further optimizing the coordinate system to be referenced. The processing illustrated in FIG. 28 will be described below with reference to a specific example.

In step S2800, the coordinate system estimation unit 103 acquires images to be subjected to the feature point detection processing. According to the present modification, the CPU 111 acquires, for example, the face images 2200 to 2209 in FIG. 22.

In step S2801, the coordinate system estimation unit 103 acquires the coordinate system to be referenced having been determined in the past. According to the present modification, the coordinate system estimation unit 103 acquires the coordinate system W₁ assuming that the coordinate system W₁ is the optimum coordinate system according to the second exemplary embodiment.

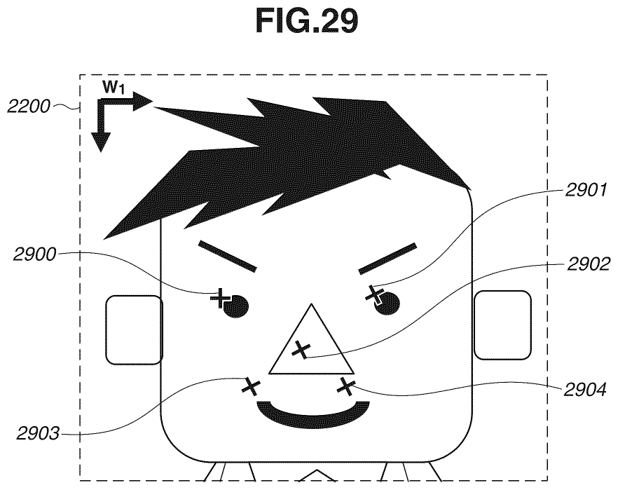

In step S2802, the coordinate system estimation unit 103 acquires a result of detecting feature points having been detected in the past. According to the present modification, the CPU 111 acquires a result of detecting feature points in the face images 2200 to 2209 in FIG. 22 based on the coordinate system W₁. FIG. 29 illustrates an example of a result of detecting feature points in the face image 2200 having been detected in the past. Referring to FIG. 29, feature points 2900 to 2904 indicate feature points having been detected in the past.

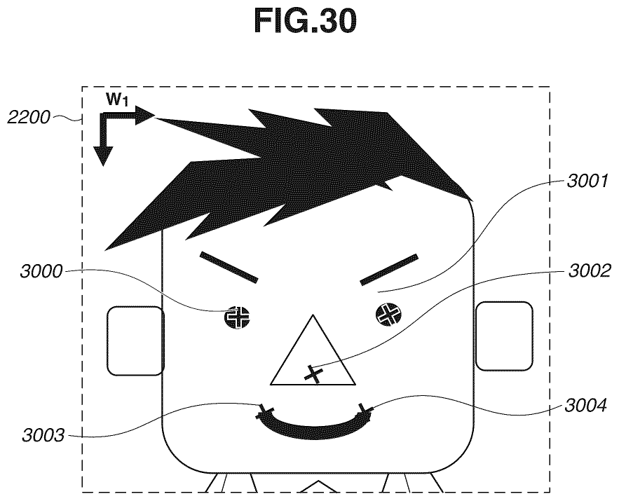

In step S2803, the coordinate system estimation unit 103 generates truth values for feature points. According to the present modification, the CPU 111 generates information about correct positions of feature points for each of the face images 2200 to 2209 in a manual operation on a user interface via the input I/F 116. Feature points 3000 to 3004 illustrated in FIG. 30 indicate the positions of five different feature points determined in a manual operation on the user interface.

In step S2804, the coordinate system estimation unit 103 acquires a coordinate system having parameters. The present modification uses the coordinate system Wₚ according to the fifth modification as a coordinate system having parameters.

In step S2805, the coordinate system estimation unit 103 calculates parameters that maximize the evaluation value.

According to the present modification, the coordinate system estimation unit 103 calculates parameters that maximize the evaluation value, with procedures similar to the procedures for optimizing the parameters of the coordinate system Wₚ according to the fifth modification. However, the present modification optimizes the parameters of the coordinate system Wₚ by using pairs of the feature points acquired in step S2802 and the truth values prepared in step S2803.

In step S2806, the coordinate system estimation unit 103 determines one coordinate system to be referenced. More specifically, the coordinate system estimation unit 103 sets the coordinate system Wₚ having the parameters obtained in step S2805, as the coordinate system to be referenced.

### Tenth Modification

The first and second exemplary embodiments determine the coordinate system to be referenced, by using an original image and a different image. On the other hand, the CPU 111 may generate a plurality of different types of different images from the original image and determine the coordinate system to be referenced, by using the plurality of different types of different images. For example, the second exemplary embodiment subjects personal faces to the feature point detection. However, the CPU 111 may generate a first different image through a homography conversion so that a face in the original image appears at the center of a generated image, and a second different image generated as a result of horizontally inverting the first different image. Then, the CPU 111 may determine the coordinate system to be referenced, by using the first and second different images.

### Eleventh Modification

The first and second exemplary embodiment detect feature points from a vehicle and personal faces. However, other objects may be subjected to the feature point detection. For example, the CPU 111 may detect joint positions such as the elbows, waist, and knees from the entire personal body as feature points. Alternatively, the CPU 111 may use a method for detecting natural feature points having no specific label without premising a specific subject.

### Twelfth Modification

The first and second exemplary embodiments determine one coordinate system to be referenced to be applied to all of feature points to be detected by the feature point detector. However, the tendency of the coordinate position may differ for each subset of feature points depending on the characteristics of the feature point detector. Then, the CPU 111 may divide the detected feature points into a plurality of subsets and determine one coordinate system to be referenced for each subset of feature points. For example, if feature points are detected from a personal face, the CPU 111 forms two different subsets including a set of only feature points detected from the right and left eyes and a set of only feature points detected from the right and left end points of the mouse. Then, the CPU 111 may determine the coordinate system to be referenced for these subsets. If feature points are detected from the entire personal body, as illustrated in the eleventh modification, the CPU 111 may determine one coordinate system to be referenced, by using a set of only feature points detected from the upper body, as one subset.

### Thirteenth Modification

According to the first and second exemplary embodiments, the feature point detector has only a process for detecting feature points from an input image. However, a detector having a plurality of different processes is also applicable. Examples of applicable processes may include a process for generating a partial image by clipping a specific object region from the input image, and a normalization process for converting an input image or partial image into that having a predetermined size and direction. Examples of applicable processes may further include a process for converting the number of digits of numeric values indicating the coordinates of a detected feature point into a predetermined number of digits. With a detector including a plurality of different processes, the accuracy, errors, and characteristics in each process affect the result of the feature point detection. However, by using procedures similar to the procedures in the first and second exemplary embodiments, the CPU 111 can determine one coordinate system to be referenced in consideration of all the factors.

The present disclosure makes it possible to estimate the coordinate system to be referenced in detecting feature points from an image.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-113182, filed Jul. 10, 2023, which is hereby incorporated by reference herein in its entirety.

What is claimed is:

1. An image processing apparatus comprising:
one or more memories storing instructions; and
one or more processors that, upon execution of the stored instructions, are configured to:
perform predetermined conversion processing on a first image including a subject to generate a second image;
detect feature points of the subject from the first and second images; and
determine a reference coordinate system for a detector for detecting feature points based on a relation between a result of detecting feature points in the first image and a result of detecting feature points in the second image.

2. The image processing apparatus according to claim 1, wherein, the reference coordinate system is determined based on a difference between a result of performing inverse conversion for the predetermined conversion processing on feature points detected from the second image and the result of detecting feature points in the first image.

3. The image processing apparatus according to claim 2, wherein the one or more processors perform association between the result of performing the inverse conversion for the predetermined conversion processing on the feature points detected from the second image and the result of detecting feature points in the first image, and determine the reference coordinate system based on a positional difference between the associated feature points.

4. The image processing apparatus according to claim 3, wherein the one or more processors detect feature points related to the subject, applies labels to the detected feature points, and associates the feature points based on the applied labels.

5. The image processing apparatus according to claim 3, wherein the one or more processors perform association between feature points having a shortest distance between coordinates of the feature points.

6. The image processing apparatus according to claim 3, wherein the one or more processors perform association between feature points having a minimum difference in a feature quantity or feature vector between feature points.

7. The image processing apparatus according to claim 2,
wherein the one or more processors further acquire coordinate system candidates, and
wherein the one or more processors perform the inverse conversion for the predetermined conversion processing for each of the acquired candidates and determine the candidate having a minimum difference between detection results as the reference coordinate system.

8. The image processing apparatus according to claim 7,
wherein the coordinate system candidates include coordinate systems having variable parameters, and
wherein one or more processors calculate the parameters so that the difference between the detection results is minimized, and determine the reference coordinate system.

9. The image processing apparatus according to claim 1, wherein the one or more processors determine the reference coordinate system by further using truth values for coordinates of the feature points.

10. The image processing apparatus according to claim 1,
wherein the one or more processors detect feature points related to the subject, and divide the detected feature points into a plurality of sets, and
wherein the one or more processors determine the reference coordinate system for each set.

11. The image processing apparatus according to claim 1,
wherein the one or more processors classify the first image into any one of a plurality of sets based on an imaging condition of the first image, and
wherein the one or more processors determine the reference coordinate system for each of the classified sets.

12. The image processing apparatus according to claim 1, wherein the one or more processors enlarge or reduce the first image, perform the predetermined conversion processing on the enlarged or reduced first image, and generate the second image.

13. The image processing apparatus according to claim 1, wherein the one or more processors generate the second image so that a predetermined resolution is obtained.

14. The image processing apparatus according to claim 1, wherein the predetermined conversion processing includes horizontal inversion, vertical inversion, translation, enlargement, reduction, rotation, shearing, trapezoidal conversion, and a combination thereof.

15. The image processing apparatus according to claim 1, wherein the predetermined conversion is a homography conversion.

16. The image processing apparatus according to claim 1,
wherein the one or more processors select the first image as an image to be used in determining the reference coordinate system, and
wherein, for the first image, an integrated value of differences between a result of performing inverse conversion for the predetermined conversion processing on feature points detected from the second image and the result of detecting feature points in the first image for different feature points is less than a predetermined value.

17. An image processing method comprising:
performing predetermined conversion processing on a first image including a subject to generate a second image;
detecting feature points of the subject from the first and second images; and
determining a reference coordinate system for a detector for detecting feature points based on a relation between a result of detecting feature points in the first image and a result of detecting feature points in the second image.

18. A non-transitory computer-readable storage medium that stores a program for causing a computer to:
perform predetermined conversion processing on a first image including a subject to generate a second image;
detect feature points of the subject from the first and second images; and
determine a reference coordinate system for a detector for detecting feature points based on a relation between a result of detecting feature points in the first image and a result of detecting feature points in the second image.
